(19) United States
(12) Patent Application Publication
(10) Pub. No.: US 2026/0194133 A1
(43) Pub. Date: Jul. 9, 2026

(54) SPUR GEAR HOUSING FOR RECEIVING A SPUR GEAR STAGE

(71) Applicant: ZF Friedrichshafen AG, Friedrichshafen (DE)

(72) Inventors: Simon HETMANIOK, Witten (DE); Christian LOHMANN, Witten (DE); Jens BETKE, Witten (DE)

(73) Assignee: ZF Friedrichshafen AG, Friedrichshafen (DE)

(21) Appl. No.: 19/129,527

(22) PCT Filed: Oct. 16, 2023
(86) PCT No.: PCT/EP2023/078607

§ 371 Date: May 13, 2025

(30) Foreign Application Priority Data
Nov. 15, 2022 (DE) 10 2022 212 089.2

(51) Int. Cl. F16H 57/025; F16H 57/03; F16H 57/031

(52) U.S. Cl. CPC F16H 57/025; F16H 57/03; F16H 57/031

(57) ABSTRACT

A spur gear housing designed to accommodate a spur gear stage of a transmission has a reinforcement structure configured to absorb a force acting upon the spur gear housing, stud structures each designed for the attaching of at least one attachment means for the spur gear housing, and a plurality of connection structures each designed to provide at least one supply element of the spur gear stage. The reinforcement structure has radially outer receiving areas and radially inner reinforcement areas distributed circumferentially. The stud structures and the connection structures are distributed circumferentially and are provided in a number which is larger than the number required for the use of the spur gear stage.

### RELATED APPLICATIONS

This application claims the benefit under 35 U.S.C. § 371 as a U.S. National Phase Application of application no. PCT/EP2023/078607, filed on 16 Oct. 2023, which claims the benefit of German Patent Application no. 10 2022 212 089.2 filed on 15 Nov. 2022, the contents of which are hereby incorporated herein by reference in their entireties.

### TECHNICAL FIELD

The present invention relates to a spur gear housing with a plurality of structures, which are arranged in the circumferential direction of the spur gear housing. The spur gear housing is designed for the optional accommodation of and for operation with various configurations of spur gear stages.

### BACKGROUND

Industrial transmissions for the driving of industrial machinery are known. These industrial transmissions consist of a plurality of housings in which various transmission sections are accommodated. The housings are produced individually in accordance with the customer's wishes.

### SUMMARY

One aspect of the present invention relates to a spur gear housing designed to accommodate a spur gear stage of a transmission. The transmission can be an industrial transmission for transmitting torque from a motor to an industrial machine. An industrial machine can be understood to mean, for example, a rock mill for breaking up rock fragments, a machine for processing cement, or comparable machines, which undergo severe impacts. A spur gear stage can be the first transmission stage in the torque transmission chain. The spur gear stage can be connected to the motor by way of a drive input shaft. Alternatively, or in addition, the spur gear stage can be connected to an industrial machine by way of a drive output shaft of the transmission. By means of the spur gear stage, a first transmission ratio can be obtained in the transmission. To produce the first transmission stage, the spur gear stage can comprise at least two gearwheels which can be brought into mechanical and functional connection with one another for the transmission of torque. The spur gear housing can be made of a metallic material. The spur gear housing can have a hollow space in which the spur gear stage can be accommodated. The spur gear housing can be made in two or more parts. The spur gear housing can be connected to other transmission housings.

The spur gear housing comprises a reinforcement structure which is designed to absorb a force acting upon the spur gear housing. A force acting upon the spur gear housing can be understood to be a force produced during the operation of the transmission. For example, the rotating drive input shaft or the rotating drive output shaft of the transmission can be mounted in the spur gear housing. Thereby, for example, the spur gear housing can be subjected to a shear force or a torque. Alternatively, or in addition, the spur gear housing can be subjected to vibrations during the transport and operation of the transmission or the spur gear housing. These vibrations can likewise result in a force acting upon the spur gear housing. Alternatively, or in addition, the spur gear housing can be subjected to a tensile force or a compressive force due to the connection of the spur gear housing with other housings of the transmission.

A structure can denote part of the spur gear housing which is designed for a particular purpose. A structure can be divided into a plurality of part-structures, which can be formed analogously to the structure. Alternatively, the part-structures can be combined to form the structure.

A reinforcement structure can be understood to be part of the spur gear housing which is deformed not at all or only very slightly under the action of the force acting upon the spur gear housing. The reinforcement structure can be designed to guide the force acting upon the spur gear housing in a specific direction, for example along a longitudinal direction of the reinforcement structure. Alternatively, or in addition, the reinforcement structure can be designed to absorb the force acting upon the spur gear housing, so that the force is not transmitted to other parts of the spur gear housing. For example, compared with adjacent parts of the spur gear housing, the reinforcement structure can have a larger area moment of inertia. Alternatively, or in addition, the reinforcement structure can have a geometric feature, for example a plurality of ribs or a layered configuration, which is suitable for dissipating the force acting upon the spur gear housing.

The spur gear housing also comprises a plurality of stud structures, each of which is designed for the fixing of at least one attachment means for the spur gear housing. An attachment means can be understood to mean a fixing means that can be attached to the spur gear housing, by means of which the spur gear housing can be fixed or held during transport or during the operation of the transmission. For example, an attachment means can be an eyelet that can be screwed into the spur gear housing, to which a cable or a chain can be attached. Preferably, round slings and chains are used. Alternatively, an attachment means can be understood to be a connection element, for example a bar element by means of which the spur gear housing can be fastened to a fixing structure such as a frame or a base. The attachment means can be fixed detachably to the stud structure. For example, it can be provided that the attachment means for transporting the spur gear housing is fixed to the stud structure. Before the operation of the transmission begins, the attachment means can be taken off again.

The stud structures can have at least one surface to which the attachment means can be fixed. For example, the surface can be provided with a bore into which the attachment means can be screwed. Other ways of fixing an attachment means are also conceivable provided that the same function is fulfilled. Alternatively, or in addition, the stud structures can be designed so as to counteract a force exerted on the attachment means, such as a tensile force acting on the attachment means.

The spur gear housing also comprises a plurality of connection structures, each of which is designed to provide at least one supply element of the spur gear housing. A supply element of the spur gear housing can be, for example, an oil level sensor that can detect an oil level inside the spur gear housing. Alternatively, or in addition, a supply element can be a temperature sensor which can detect a temperature within the spur gear housing. Further examples of a supply element of the spur gear stage can be a supply line for supplying the spur gear stage with electric current, or a supply line for supplying the spur gear stage with a lubricant.

The at least one supply element can be provided by pre-processing the connection structures. For example, the connection structures can be provided with bores, polished, ground, coated, or pre-processed in some different way in order to be able to attach the supply element to the spur gear housing. Alternatively, or in addition, the connection structures can be provided with a connecting element, for example a flange to which the supply element can be fixed. It can be provided that a connection structure is provided for more than one supply element of the spur gear stage. Alternatively, or in addition, it can be provided that a supply element is provided on more than one of the connection structures.

The reinforcement structure can include radially outer receiving areas and radially inner reinforcement areas. The receiving areas and the reinforcement areas can be arranged so as to be distributed around the circumferential direction of the spur gear housing. Here, the radial direction of the spur gear housing can be defined starting from a longitudinal axis of the spur gear housing. The receiving areas can have at least one surface or area which is designed to absorb the force acting upon the spur gear housing. The reinforcement areas can be designed to dissipate the force absorbed. For example, the reinforcement areas may have a material thickness larger than that of adjacent areas of the spur gear housing. Alternatively, or in addition, the reinforcement areas can have a geometrical configuration designed to dissipate the force, for example a plurality of stiffening ribs or a plurality of stiffening layers. The circumferential direction of the spur gear housing can correspond to a direction along an outer periphery of the spur gear housing. The receiving areas and the reinforcement areas can comprise, for example, a plurality of respectively similar structural elements which are arranged around the circumferential direction at specified distances or at specified angles apart relative to one another. Alternatively, or in addition, the receiving areas and the reinforcement areas can comprise a plurality of different structural elements which are arranged at specified distances or at specified angles apart relative to one another. Thus, the reinforcement structure is arranged around the entire circumference of the spur gear housing.

The stud structures and the attachment structures are in each case distributed in the circumferential direction of the spur gear housing and provided in a number greater than the number required for the use of the spur gear stage. One use of the spur gear stage can be understood to mean the installation or fitting of the spur gear stage into the spur gear housing. In addition, one use of the spur gear stage can be understood to mean the operation or use of the spur gear stage as part of a transmission. For the use of the spur gear stage, for example, only one, or two, or three of the stud structures may be needed. Alternatively, or in addition, for the use of the spur gear stage, for example, only one, or two, or three of the connection structures may be needed. Thus, as a rule, not all of the existing stud or connection structures are used. Rather, from the plurality of stud structures or the plurality of connection structures, only those can be chosen which are necessary or advantageous for the use selected.

The proposed spur gear housing enables a variable adaptation of the spur gear housing to various installation positions. Thanks to the larger number of stud structures or connection structures it is ensured that many of the particular structures are present in the circumferential direction. Consequently, the spur gear housing can be turned to a preferred installation position or fitted in that position, in which for example the supply elements or connection means can be attached particularly suitably to the spur gear housing. Owing to the larger number of stud structures and connection structures, their exact position does not have to be taken into account when installing the spur gear housing. Furthermore, the proposed spur gear housing enables a variable adaptation of the spur gear housing to various arrangements of the spur gear stage accommodated in the spur gear housing. Thanks to the larger number of stud structures or connection structures, various spur gear stages can be used in the spur gear housing without having to take into account the exact position of the structures concerned. Accordingly, the proposed spur gear housing can be used in many different installation positions with many different spur gear stages. Finally, the reinforcing structure is distributed around the entire circumference of the spur gear housing. Thus, its arrangement too, when the spur gear stage chosen is used, does not have to be taken into account. Rather, the reinforcement structure ensures increased rigidity of the spur gear housing with any desired use of the spur gear stage. Thus, the proposed spur gear housing is suitable for many different uses of the spur gear stage while at the same time its rigidity is increased.

In an embodiment, the receiving areas and the reinforcement areas are arranged in alternation around the circumference of the spur gear housing. The receiving areas and the reinforcement areas can be arranged in alternation in the circumferential direction of the spur gear housing in such manner that in the circumferential direction each reinforcement area is followed by a receiving area and each receiving area is followed by a reinforcement area. Thanks to the alternating arrangement of the reinforcement and receiving areas, the force absorbed can be absorbed along the entire circumference of the spur gear housing and dissipated. This increases the rigidity of the spur gear housing.

According to a further embodiment, the reinforcement structure extends with undulations in the circumferential direction of the spur gear housing. An undulating course of the reinforcement structure can be understood to mean a reinforcement structure which has an essentially continuous outer contour which is in the form of repeated radially outward elevations and radially inward depressions. It can be provided that the peaks of the elevations or the troughs of the depressions are not sharp but flattened. By virtue of the undulating course the wall thickness of the housing can be reduced and the rigidity in relation to bending loads can be increased.

In a further embodiment, the undulating reinforcement structure has an essentially constant wall thickness. A wall thickness can be understood to mean a distance between a radially external outside and a radially internal inside of the undulating structure that extends circumferentially. That distance can be essentially constant around the entire circumference of the spur gear housing. In that way, material can be saved without thereby reducing the rigidity of the spur gear housing.

In an embodiment, the stud structures can each have at least one radially outer stud area for attaching the at least one attachment means, and at least one radially inner reinforcement area for dissipating a force that acts upon the stud structures. Here, the radial direction of the spur gear housing can be defined starting from a longitudinal axis of the spur gear housing. The attachment area can have at least one surface which is designed for receiving the attachment means. The reinforcement area can for example have a larger material thickness compared with the adjacent areas of the spur gear housing. Alternatively, or in addition, the reinforcement area can have a geometrical configuration designed to dissipate the force, such as a plurality of stiffening ribs or a plurality of stiffening layers. By virtue of the arrangement of the stud area radially outside the reinforcement area, a force acting by way of the attachment means from outside upon the spur gear housing can simply be absorbed and deflected into the reinforcement area. This ensures sufficient carrying capacity for transport.

In a further embodiment, the attachment area is in the form of an attachment cam, and the reinforcement area is in the form of a reinforcing rib. An attachment cam can be understood to be a cylindrical or conical element which has an essentially flat top side. The top side can be designed for the fixing of the attachment means. A stiffening rib is understood to be a reinforcing area whose extension in the longitudinal direction can be considerably larger than in the transverse direction. Alternatively, or in addition, it can be provided that the stiffening rib tapers down radially toward the inside. By virtue of their respective designs, an attachment cam or a stiffening rib is particularly suitable for fixing the attachment means or for dissipating the force that is acting.

According to a further embodiment, a plurality of attachment cams are arranged a specified distance apart from one another in the circumferential direction of the spur gear housing. The specified distance can be defined on the basis of an angle. For example, the plurality of attachment cams can be arranged at an angle of 30° or 45° or 60° or 90° or 120° relative to one another in the circumferential direction. For example, two respective attachment cams can be arranged at an angle of 60° relative to one another and two of them at an angle of 120° relative to one another in the circumferential direction. Other combinations of angular arrangements of the attachment cams are also conceivable. Thanks to the specified separations, the arrangement of the attachment cams can be adapted for numerous uses of the spur gear housing.

In another embodiment, the stud structures can be arranged at least in part offset toward the inside relative to the radially outer attachment area of the reinforcement structure. For example, the reinforcement structure can have an undulating form with wave peaks and wave troughs. In each case one of the stud structures can be arranged between two wave peaks. Further designs of the reinforcing structure and the relative arrangement of the connection structures are also conceivable within the scope of the invention. Thanks to the radially inward offset of the stud structures relative to the receiving areas, the fitting space existing in the spur gear housing can be used to best effect.

According to a further embodiment, the stud structures can be arranged around the circumference of the spur gear housing with essentially equal separations from one another. The separation can be based on a specified angle. For example, the stud structures can be arranged in the circumferential direction at an angle of 30°, or 45°, or 60°, or 90° or 120° relative to one another. Furthermore, the stud structures can be arranged around the circumference in a combination of more than one angle relative to one another. For example, two respective stud structures can be arranged at an angle of 45° and two of them at an angle of 90° relative to one another in the circumferential direction. Other combinations of angular arrangements are also conceivable. Due to the essentially equal separations, the arrangement of the stud structures can be adapted to the chosen use of the spur gear housing.

According to a further embodiment, the stud structures can have an essentially flat connection area for providing the at least one supply element. An essentially flat connection area can be understood to mean an area of the stud structure whose curvature is less than a specified threshold value. An essentially flat connection area can be machined particularly suitably for providing the supply element. The provision of the supply element by virtue of the mechanical machining is thus facilitated by the essentially flat connection area.

Another embodiment of the spur gear housing can comprise at least one holding means connected to the spur gear housing for holding a lubricant line for the spur gear stage. The holding means can be, for example, in the form of a cylindrical opening into which the lubricant line can be inserted. Alternatively, the holding means can be, for example, in the form of a groove in which the lubricant line can be guided. A lubricant line can be understood, for example, to be a tubular line through which a lubricant such as a lubricating oil can be delivered to the spur gear stage. Thanks to the connection of the holding means to the spur gear housing, any mechanical finish-machining of the spur gear housing during the fitting of the lubricant line is no longer needed, or is only needed with very little effort.

According to a further embodiment, the spur gear housing comprises a housing pot and a housing cover that can be fitted onto the housing pot. The housing pot can be that part of the spur gear housing which can be attached to a further transmission housing. The housing cover can be that part of the spur gear housing which faces toward a motor connected to the spurt gear stage. The housing pot and the housing cover fitted thereto, between them, can for example form a hollow space in which the spur gear stage can be accommodated. The two-part design of the spur gear housing facilitates the installation of the spur gear stage.

In an embodiment, a further reinforcement structure can be provided on the housing cover, which extends with undulations along the circumferential direction of the housing cover. The further reinforcement structure can extend analogously to the reinforcement structure described earlier, with undulations along the circumference of the housing cover. By forming an undulating reinforcement structure both on the housing pot and on the housing cover, the rigidity of the two-part spur gear housing can be increased still more.

According to a further embodiment, a plurality of further connection structures can be provided on the housing cover. The further connection structures can all be distributed in the circumferential direction of the spur gear housing. The distribution in the circumferential direction and the number of further connection structures can be analogous to the distribution in the circumferential direction and the number of stud structures in the embodiments explained earlier. By forming further connection structures on the housing cover the adaptability of the spur gear housing to a variety of uses of the spur gear stage can be increased even more.

In a further embodiment, the spur gear housing can be designed for the optional accommodation and operation of different configurations of spur gear stages. For example, the spur gear stages can vary in relation to a torque category. Alternatively, or in addition, the spur gear stages can vary in relation to their geometrical dimensions, their installation position, or the purpose for which they are intended. One of the different configurations of spur gear stages can always be used in the spur gear housing. By virtue of the design of the spur gear stage according to the invention, however, the spur gear housing can be used with all the various configurations of spur gear stages.

According to a further embodiment, on its drive output side the spur gear housing can have a connection section for connecting the spur gear housing to another transmission housing and a receiving section for accommodating the spur gear stage. In this case the diameter of the connection section can be smaller than the diameter of the receiving section. The connection section and the receiving section can be made integrally as one piece. Alternatively, the connection section can be assembled onto the receiving section. For example, a diameter of the receiving section can be defined by a diameter of the spur gear stage accommodated in it. A diameter of the connection section can be defined, for example, by a diameter of the further transmission housing. Owing to the smaller diameter of the connection section, the spur gear housing can also be used with other transmission housings which have a smaller diameter than the spur gear housing. This improves the utilization options of the spur gear housing.

### BRIEF DESCRIPTION OF THE DRAWINGS

FIG. 1: shows a schematic representation of a spur gear housing with a housing pot and a housing cover according to an embodiment of the invention.

FIGS. 2a-2c: show schematic representations of various views of a housing pot of the spur gear housing according to an embodiment of the invention.

FIGS. 3a-3b: show schematic representations of various views of a housing cover of the spur gear housing according to an embodiment of the invention.

FIGS. 4a-4c: show schematic representations of various views of a reinforcement structure and a stud structure of the spur gear housing according to an embodiment of the invention.

### DETAILED DESCRIPTION OF EMBODIMENTS

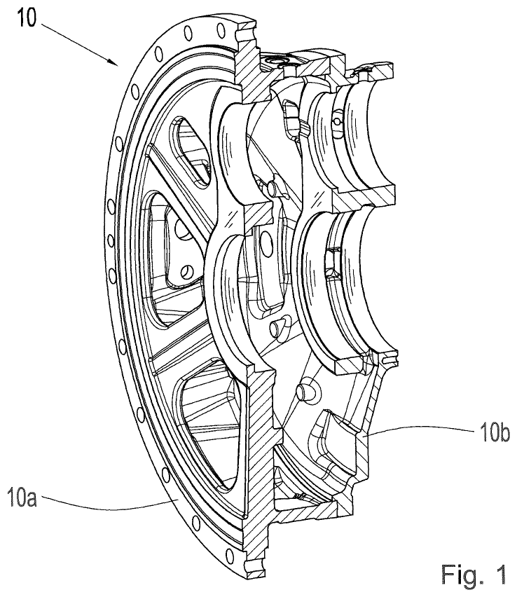

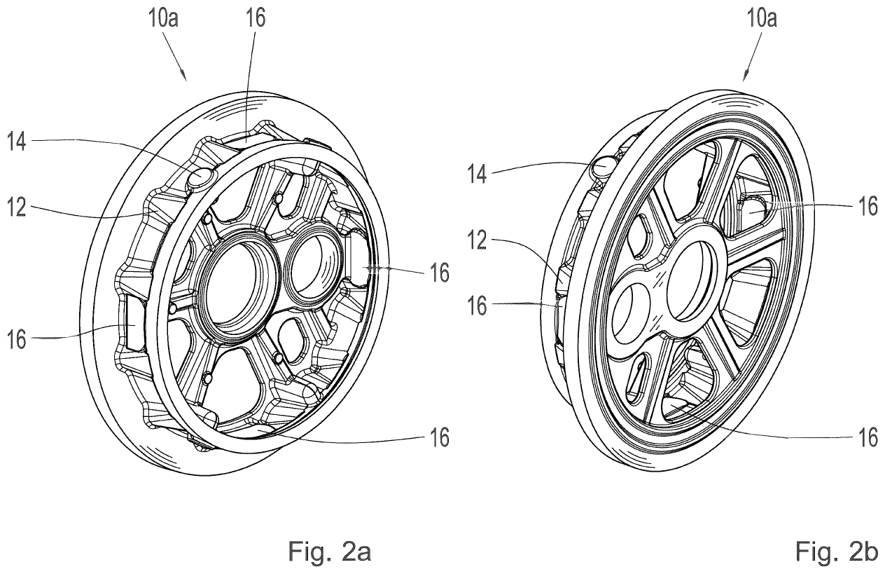

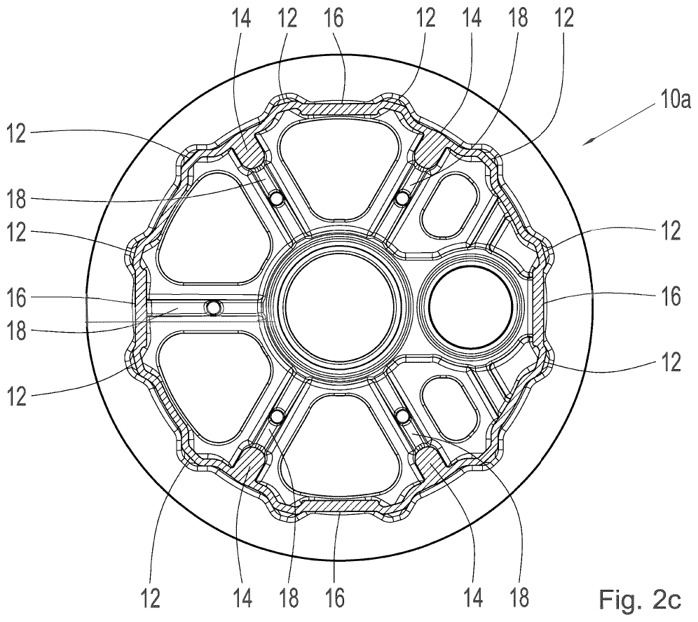

FIG. 1 shows a schematic representation of a spur gear housing 10 according to an embodiment of the invention. The spur gear housing 10 comprises a housing pot 10a and a housing cover 10b. Between the housing pot 10a and the housing cover 10b a hollow space is formed, in which a spur gear stage (not shown) can be accommodated. The spur gear housing is designed with various structures for improving its rigidity and its adaptability to different installation positions of the spur gear stage, which will be described in greater detail with reference to FIGS. 2 to 4.

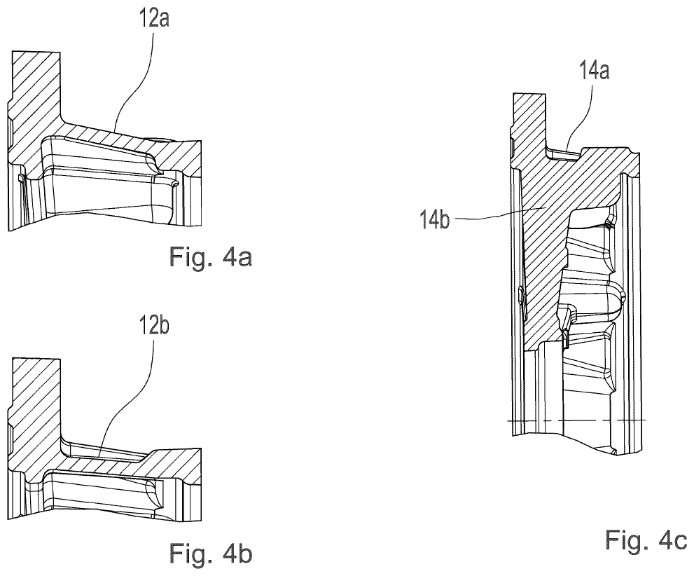

FIGS. 2a to 2c show schematic representations of various views of a housing pot 10a of the spur gear housing 10 from the example embodiment of FIG. 1. The housing pot 10a of the spur gear housing 10 has a reinforcement structure 12 for absorbing a force that acts upon the spur gear housing 10. Further details of the design of the reinforcement structure 12 will be explained with reference to FIGS. 4a and 4b.

FIGS. 4a and 4b show detailed views of the reinforcement structure 12 of the spur gear housing 10. As can be seen in the example embodiment of FIG. 4a, the reinforcement structure 12 comprises a radially outer receiving area 12a for absorbing a force that acts upon the spur gear housing. In the example embodiment shown in FIG. 4a, the receiving area 12a is formed by a radially outer wave peak of the undulating reinforcement structure 12. As can be seen from the example embodiment shown in FIG. 4b, the reinforcement structure 12 also comprises an inner reinforcement area 12b. In the example embodiment shown in FIG. 4b. the reinforcement area 12b is formed by a radially inner wave trough of the undulating reinforcement structure 12.

The housing pot 10a of the spur gear housing 10 also comprises a plurality of stud structures 14, each of which is designed for the attachment of at least one attachment means for the spur gear housing 10. In the representations shown in FIGS. 2a and 2b, the stud structures 14 are shown as attachment cams. As can be seen for example from the representation shown in FIG. 2c, a plurality of attachment cams 14 are arranged a specified distance apart from one another in the circumferential direction of the housing pot 10a of the spur gear housing 10. In the example embodiment shown in FIG. 2c, respective pairs of attachment cams 14 are arranged at an angle of 60° relative to one another. In addition, respective pairs of attachment cams 14 are arranged at an angle of 120° relative to one another. Thus, the spur gear housing can correspondingly be rotated by 60 ° or by 120° in order to select an appropriate attachment structure 14 for the attachment of at least one attachment means for the spur gear housing 10. The further design features of the attachment structures 14 will be explained in greater detail with reference to FIG. 4c.

FIG. 4c shows a detailed view of the attachment structures 14 of the spur gear housing 10. As can be seen from the example embodiment shown in FIG. 4c, the attachment structures 14 comprise a radially outer attachment area 14a for the attachment of at least one connection means, and at least one radially inner reinforcement area 14b for dissipating a force acting upon the attachment structures 14. In the example embodiment of FIG. 4c, the attachment structure 14a is in the form of an attachment cam and the reinforcing area is in the form of a stiffening rib.

Furthermore, the housing pot 10a of the spur gear housing 10 comprises a plurality of connection structures 16, each of which is designed to provide at least one supply element of the spur gear stage. The connection structures 16 have an essentially flat surface, as shown in FIGS. 2a and 2c. The essentially flat surface for providing the supply element can be mechanically machined with little effort. As can be seen in the example embodiment shown in FIG. 2c, the connection structures 16 are arranged so as to be separated by an angle of 90° relative to one another in the circumferential direction of the spur gear housing 10. Thus, the spur gear housing 10 can be rotated in each case by 90° in order to select an appropriate connection structure 16 for providing the supply element.

Referring to the embodiment shown in FIG. 2c, a plurality of holding means 18 are connected to the spur gear housing 10. The holding means 18 are designed to hold a lubricant line for the spur gear stage. In the embodiment shown in FIG. 2c, the holding means 18 are represented in the form of bores in a rib of the spur gear housing 10.

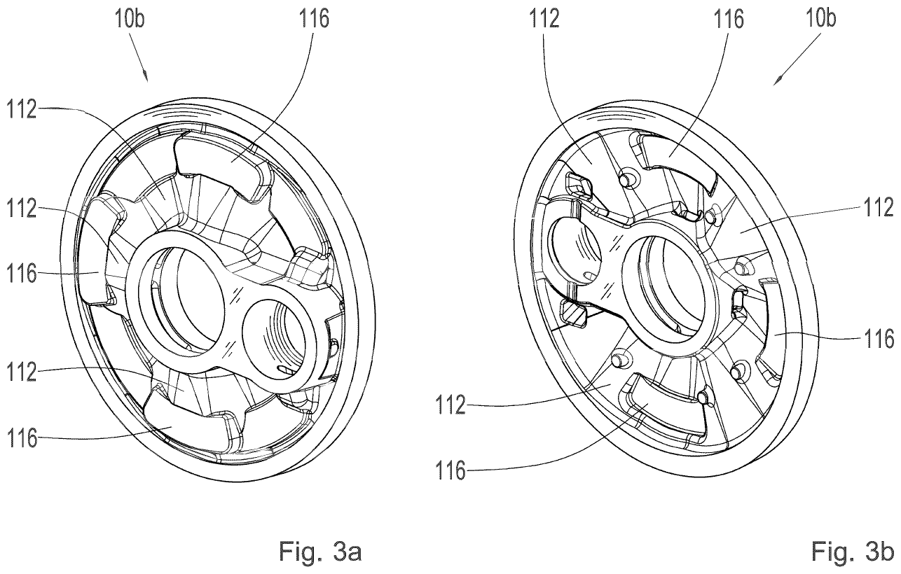

FIGS. 3a and 3b show schematic representations of different views of a housing cover 10b of the spur gear housing 10 according to the example embodiment shown in FIG. 1. On the housing cover 10b a further reinforcement structure 112 is provided, which extends with undulations around the circumferential direction of the housing cover 10b. In this case the further reinforcement structure 112 is designed analogously to the reinforcement structure 12 according to the example embodiment shown in FIGS. 2a to 2c.

Furthermore, the housing cover 10b has a plurality of further connection structures 116. The further connection structures 116 are all distributed in the circumferential direction of the housing cover 10b. The further connection structures 116 are designed analogously to the connection structure 16 according to the example embodiment shown in FIGS. 2a to 2c.

### INDEXES

10 Spur gear housing
10a Housing pot
10b Housing cover
12; 112 Reinforcement structure
12a Receiving area, wave peak
12b Reinforcement area, wave trough
14 Stud structures
14a Connection area, connection cam
14b Reinforcement area, reinforcing rib
16; 116 Connection structures
18 Holding means

1. A spur gear housing (10) comprising:
a reinforcement structure (12; 112) configured to absorb a force acting upon the spur gear housing;
a plurality of stud structures (14) each configured to form at least one connection means for the spur gear housing (10); and
a plurality of connection structures (16; 116) each configured for the provision of at least one supply element of the spur gear stage;
wherein the reinforcement structures (12; 112) comprise radially outer receiving areas (12a) and radially inner reinforcement areas (12b) distributed around the circumferential direction of the spur gear housing (10);
wherein the stud structures (14) and the connection structures (16; 116) are all distributed in the circumferential direction of the spur gear housing (10) and are provided in a number which is larger than the number required for the use of the spur gear stage; and
wherein the spur gear housing is configured to accommodate a spur gear stage of a transmission.

2. The spur gear housing (10) according to claim 1, wherein the receiving areas (12a) and the reinforcement areas (12b) are arranged in alternation around the circumferential direction of the spur gear housing (10).

3. The spur gear housing (10) according to claim 2, wherein the reinforcement structure (12; 112) extends in the circumferential direction of the spur gear housing in an undulating manner.

4. The spur gear housing (10) according to claim 3, wherein the undulating reinforcement structure (12; 112) has an essentially constant wall thickness.

5. The spur gear housing (10) according to claim 1, wherein the stud structures (14) comprise at least one radially outer attachment area (14a) for the fixing of at least one attachment means, and at least one radially inner reinforcement area for dissipating a force acting upon the stud structures (14).

6. The spur gear housing (10) according to claim 5, wherein the attachment area (14a) is in the form of an attachment cam and the reinforcement area (14b) is in the form of a reinforcing rib.

7. The spur gear housing (10) according to claim 6, comprising a plurality of attachment cams arranged a specified distance apart from one another around the circumferential direction of the spur gear housing (10).

8. The spur gear housing according to claim 1, wherein the connection structures (16; 116) are arranged at least in part offset radially inward relative to the outer receiving areas (12a).

9. The spur gear housing (10) according to claim 8, wherein the connection structures (16; 116) are arranged around a circumferential direction of the spur gear housing (10) at essentially equal distances apart from one another

10. The spur gear housing (10) according to claim 9, wherein the connection structures (16, 116) have an essentially flat attachment area for the provision of the at least one supply element.

11. The spur gear housing according to claim 1, comprising at least one holding means (18) [is] connected to the spur gear housing (10) and configured for holding a lubricant line for the spur gear stage.

12. The spur gear housing (10) according to claim 1, wherein the spur gear housing (10) consists of a housing pot (10a) and a housing cover (10b) that can be fitted onto the housing pot (10a).

13. The spur gear housing (10) according to claim 12, comprising a further reinforcement structure (112) on the housing cover (10b), and extends in a circumferential direction of the housing cover (10b) in an undulating manner.

14. The spur gear housing (10) according to claim 13, comprising further connection structures (116) on the housing cover (10b), wherein the further connection structures (116) are distributed in the circumferential direction of the spur gear housing (10).

15. The spur gear housing (10) according to claim 1, wherein the spur gear housing (10) is configured for the selective accommodation of, and for the operation of various configurations of spur gear stages.

16. The spur gear housing according to claim 1, comprising a connection section on a drive output side and configured for connecting the spur gear housing (10) to another transmission housing, and comprising a receiving section for accommodating the spur gear stage, wherein a diameter of the connection section is smaller than a diameter of the receiving section.
